(19) United States
(12) Patent Application Publication
(10) Pub. No.: US 2015/0206478 A1
(43) Pub. Date: Jul. 23, 2015

(54) ELECTROPHORETIC DISPLAY DEVICE, DRIVE METHOD OF ELECTROPHORETIC DISPLAY DEVICE, CONTROL CIRCUIT, AND ELECTRONIC APPARATUS

(71) Applicant: Seiko Epson Corporation, Tokyo (JP)

(72) Inventor: Katsunori Yamazaki, Matsumoto-shi (JP)

(21) Appl. No.: 14/597,701

(22) Filed: Jan. 15, 2015

(30) Foreign Application Priority Data
Jan. 21, 2014 (JP) 2014-008794

(51) Int. Cl. G09G 3/34; G09G 5/18; G02F 1/167

(52) U.S. Cl. CPC G09G 3/344; G02F 1/167; G09G 5/18; G09G 2300/04

(57) ABSTRACT

An electrophoretic display device, when an image is switched from a first image to a second image, performs a first control operation that replaces a first control signal which is input to a first control line with a second control signal which is input to a second control line so that the second control signal is input to a pixel electrode using the first control line and the first control signal is input to the pixel electrode using the second control line, when the first image is displayed on a display unit before the image is switched, and performs a second control operation that generates inversion image data which is obtained by inverting image data corresponding to the second image, and inputs the inversion image data to a data line.

### BACKGROUND

1. Technical Field

The present invention relates to an electrophoretic display device, a drive method of the electrophoretic display device, a control circuit, and an electronic apparatus.

2. Related Art

In the related art, it is known that an electrophoretic display device includes a switching element, a memory circuit, and a switch circuit which is switched by an output signal of the memory circuit and switches a connection state between a pixel electrode and a first control line or a second control line, for each pixel (for example, JP-A-2010-256919).

In the electrophoretic display device of the related art, the first control line or the second control line is provided in common with respect to all pixels, and thus at least a portion of the first and second control lines is not blocked by other wires and disposed so as to face a counter electrode via an electrophoretic element. For this reason, there is a problem that, if an image display is repeated, electrophoretic particles increasingly stay in a control line, and thereby electrophoretic particles for display are reduced and display unevenness occurs.

### SUMMARY

An advantage of some aspects of the invention is that an electrophoretic display device, a drive method of the electrophoretic display device, a control circuit, and an electronic apparatus are provided in which accumulation of electrophoretic particles is prevented and thereby a good display quality is obtained.

According to a first aspect of the invention, there is provided an electrophoretic display device that includes a pair of substrates; an electrophoretic layer that is interposed between the pair of substrates and includes partition walls, and electrophoretic particles disposed in a plurality of areas partitioned by the partition walls; a display unit that includes a plurality of pixels; pixel electrodes that are formed in the plurality of pixels; a data line that is connected to the pixel; a counter electrode that opposes the plurality of pixel electrodes via the electrophoretic layer; a first control line and a second control line that are electrically connected to the pixel electrodes and do not overlap the partition walls in a planar view; and a control device that, when an image that is displayed on the display unit is switched from a first image to a second image, performs a first control operation that replaces a first control signal which is input to the first control line with a second control signal which is input to the second control line so that the second control signal is input to the pixel electrode using the first control line and the first control signal is input to the pixel electrode using the second control line, when the first image is displayed on the display unit before the image is switched, and performs a second control operation that generates inversion image data which is obtained by inverting image data corresponding to the second image, and inputs the inversion image data to the data line.

According to the electrophoretic display device relating to the first aspect, when an image of the display unit is switched, the signal that are input to the first control line and the second control line are inverted, and thus it is possible to release the electrophoretic particles temporarily accumulated on a portion corresponding the first control line and the second control line, using a repulsive force. Thus, the electrophoretic particles are unevenly distributed on the portion corresponding to the first control line and the second control line and do not stay there. Therefore, it is possible to obtain a good display quality without display unevenness by preventing the electrophoretic particles from accumulating.

In the first aspect, when a period in which all of a plurality of scan lines that are connected to the pixels are sequentially selected only once is set as one frame period, the control device may perform the first control operation and the second control operation, in at least the one frame period.

According to this configuration, it is possible to relatively frequently perform ejection of the electrophoretic particles. Thus, it is possible to reliably prevent the electrophoretic particles from accumulating and to retain a good display quality.

According to a second aspect of the invention, there is provided an electrophoretic display device that includes a pair of substrates; an electrophoretic layer that is interposed between the pair of substrates and includes partition walls, and electrophoretic particles disposed in a plurality of areas partitioned by the partition walls; a display unit that includes a plurality of pixels; pixel electrodes that are formed in the plurality of pixels; a data line that is connected to the pixel; a counter electrode that opposes the plurality of pixel electrodes via the electrophoretic layer; a first control line and a second control line that are electrically connected to the pixel electrodes and do not overlap the partition walls in a planar view; and a circuit unit that, when an image that is displayed on the display unit is switched from a first image to a second image, performs first processing that replaces a first control signal which is input to the first control line with a second control signal which is input to the second control line so that the second control signal is input to the pixel electrode using the first control line and the first control signal is input to the pixel electrode using the second control line, when the first image is displayed on the display unit before the image is switched, and performs second processing that generates inversion image data which is obtained by inverting image data corresponding to the first image, and inputs the inversion image data to the data line.

According to the electrophoretic display device relating to the second aspect, when an image of the display unit is switched, the signal that are input to the first control line and the second control line are inverted, and thus it is possible to release the electrophoretic particles temporarily accumulated on a portion corresponding the first control line and the second control line, using a repulsive force. Thus, the electrophoretic particles are unevenly distributed on the portion corresponding to the first control line and the second control line and do not stay there. Therefore, it is possible to obtain a good display quality without display unevenness by preventing the electrophoretic particles from accumulating.

In the second aspect, when a period in which all of a plurality of scan lines that are connected to the pixels are sequentially selected only once is set as one frame period, the circuit unit may perform the first processing and the second processing, in at least the one frame period.

According to this configuration, it is possible to relatively frequently perform ejection of the electrophoretic particles. Thus, it is possible to reliably prevent the electrophoretic particles from accumulating and to retain a good display quality.

According to a third aspect of the invention, there is provided a drive method of an electrophoretic display device including a pair of substrates, an electrophoretic layer that is interposed between the pair of substrates and includes partition walls and electrophoretic particles disposed in a plurality of areas partitioned by the partition walls, a display unit that includes a plurality of pixels, pixel electrodes that are formed in the plurality of pixels, a data line that is connected to the pixel, a counter electrode that opposes the plurality of pixel electrodes via the electrophoretic layer, and a first control line and a second control line that are electrically connected to the pixel electrodes and do not overlap the partition walls in a planar view, the method including performing first processing that, when an image that is displayed on the display unit is switched from a first image to a second image, replaces a first control signal which is input to the first control line with a second control signal which is input to the second control line so that the second control signal is input to the pixel electrode using the first control line and the first control signal is input to the pixel electrode using the second control line, when the first image is displayed on the display unit before the image is switched; and performing second processing that, when an image that is displayed on the display unit is switched from a first image to a second image, generates inversion image data which is obtained by inverting image data corresponding to the first image, and inputs the inversion image data to the data line.

According to the drive method of an electrophoretic display device relating to the third aspect, when an image of the display unit is switched, the signal that are input to the first control line and the second control line are inverted, and thus it is possible to release the electrophoretic particles temporarily accumulated on a portion corresponding the first control line and the second control line, using a repulsive force. Thus, the electrophoretic particles are unevenly distributed on the portion corresponding to the first control line and the second control line and do not stay there. Therefore, it is possible to obtain a good display quality without display unevenness by preventing the electrophoretic particles from accumulating.

In the third aspect, when a period in which all of a plurality of scan lines that are connected to the pixels are sequentially selected only once is set as one frame period, the first processing and the second processing may be performed, in at least the one frame period.

According to this configuration, it is possible to relatively frequently perform ejection of the electrophoretic particles. Thus, it is possible to reliably prevent the electrophoretic particles from accumulating and to retain a good display quality.

According to a fourth aspect of the invention, there is provided a control circuit of an electrophoretic display device including a pair of substrates, an electrophoretic layer that is interposed between the pair of substrates and includes partition walls and electrophoretic particles disposed in a plurality of areas partitioned by the partition walls, a display unit that includes a plurality of pixels, pixel electrodes that are formed in the plurality of pixels, a data line that is connected to the pixel, a counter electrode that opposes the plurality of pixel electrodes via the electrophoretic layer, and a first control line and a second control line that are electrically connected to the pixel electrodes and do not overlap the partition walls in a planar view, the circuit performing: a first operation that, when an image that is displayed on the display unit is switched from a first image to a second image, replaces a first control signal which is input to the first control line with a second control signal which is input to the second control line so that the second control signal is input to the pixel electrode using the first control line and the first control signal is input to the pixel electrode using the second control line, when the first image is displayed on the display unit before the image is switched; and a second operation that, when an image that is displayed on the display unit is switched from a first image to a second image, generates inversion image data which is obtained by inverting image data corresponding to the first image, and inputs the inversion image data to the data line.

According to the control circuit relating to the fourth aspect, when an image of the display unit is switched, the signal that are input to the first control line and the second control line are inverted, and thus it is possible to release the electrophoretic particles temporarily accumulated on a portion corresponding the first control line and the second control line, using a repulsive force. Thus, the electrophoretic particles are unevenly distributed on the portion corresponding to the first control line and the second control line and do not stay there. Therefore, by including the present control circuit, it is possible to produce an electrophoretic display device which has a good display quality without display unevenness by preventing the electrophoretic particles from accumulating.

According to a fifth aspect of the invention, there is provided an electronic apparatus including an electrophoretic display device according to the first aspect.

According to the electronic apparatus relating to the fifth aspect, an electrophoretic display device without display unevenness is provided, and thus the electronic apparatus itself has a good display quality and a high added value.

### BRIEF DESCRIPTION OF THE DRAWINGS

The invention will be described with reference to the accompanying drawings, wherein like numbers reference like elements.

FIG. 1 is a plan view illustrating a schematic configuration of an electrophoretic display device according to a first embodiment.

FIG. 2 is a diagram illustrating a circuit configuration of a pixel.

FIG. 3 is a schematic cross-sectional configuration diagram of an electrophoretic display device.

FIGS. 4A and 4B are operation explanatory diagrams of an electrophoretic element.

FIG. 5 is a view illustrating a configuration of one pixel.

FIG. 6 is a view illustrating a configuration of three pixels.

FIG. 7 is a timing chart when one pixel is driven.

FIGS. 8A to 8D are views for explaining a phenomenon occurring in a pixel.

FIG. 9 is a timing chart illustrating signals that are changed by a control of a controller.

FIG. 10 is a plan view illustrating a schematic configuration of an electrophoretic display device according to a second embodiment.

FIG. 11 is a diagram illustrating a schematic configuration of a control circuit.

FIG. 12 is a diagram illustrating an operation of the control circuit.

FIG. 13 is a diagram illustrating a configuration example of another pixel circuit.

FIGS. 14A to 14C are views illustrating a configuration according to an example of an electronic apparatus.

### DESCRIPTION OF EXEMPLARY EMBODIMENTS

Hereinafter, embodiments according to the invention will be described with reference to the drawings. In the embodiment, an electrophoretic display device that is driven by an active matrix method will be described as an example. In addition, in the following drawings, in order to make each configuration easy to understand, scales, numbers, or the like of each configuration are denoted differently from those of an actual configuration.

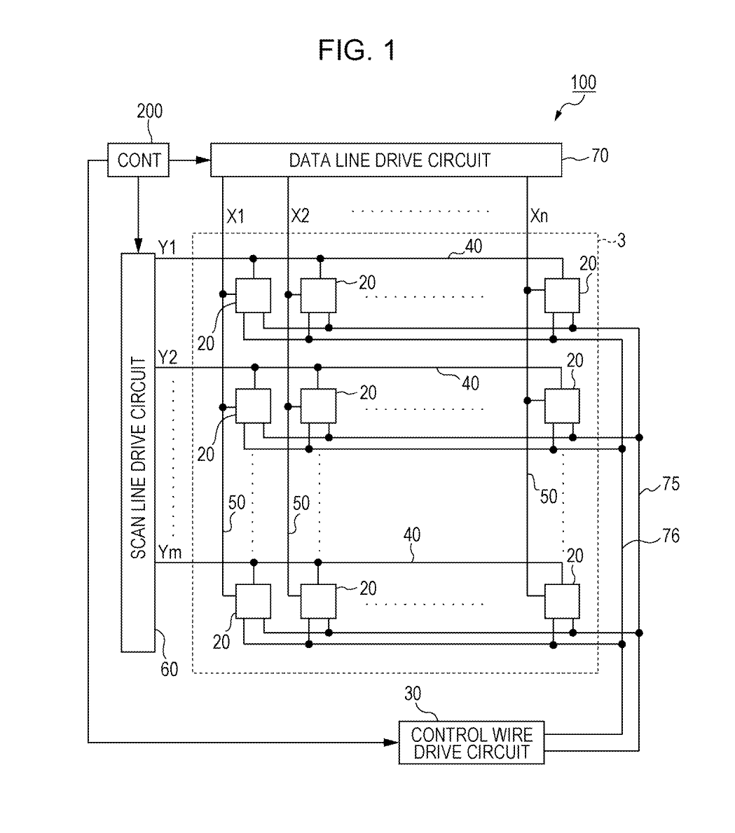

FIG. 1 is a plan view illustrating a schematic configuration of an electrophoretic display device according to the present embodiment. The electrophoretic display device 100 includes a display unit 3 in which a plurality of pixels 20 is arranged, a scan line drive circuit 60, and a data line drive circuit 70.

In the display unit 3, a plurality of scan lines 40 (Y1, Y2, . . . , Ym) extending from the scan line drive circuit 60, and a plurality of data lines 50 (X1, X2, . . . , Xn) extending from the data line drive circuit 70 are formed. A pixel 20 is disposed in correspondence to an intersection of a scan line 40 and a data line 50, and each pixel 20 is connected to a scan line 40, a data line 50, a first control line 75, and a second control line 76.

In addition, in the periphery of the display unit 3, in addition to the scan line drive circuit 60 and the data line drive circuit 70, a common power supply modulation circuit (not illustrated), or a control line drive circuit 30, and a controller (CONT) 200 are disposed. The control line drive circuit 30 inputs a predetermined potential to the first control line 75 and the second control line 76. The controller 200 is a control device that controls the respective circuits as a whole, based on image data or a sync signal that is supplied from a higher-level device. In addition, the controller 200 controls the control line drive circuit 30, and is configured so as to perform a control of inverting a control signal that is output from the control line drive circuit 30, as will be described later. In addition, as will be described later, the controller 200 is configured so as to perform a control of inversion, when the image data that is supplied from the higher-level device is rewritten.

In addition, in addition to the scan line 40 and the data line 50, a high potential power supply line 78 and a low potential power supply line 77 are connected to each pixel 20. The common power supply modulation circuit generates various signals to be supplied to the respective wires under the control of the controller 200, and performs an electrical connection and an electrical disconnection (becomes high impedance) of the respective wires.

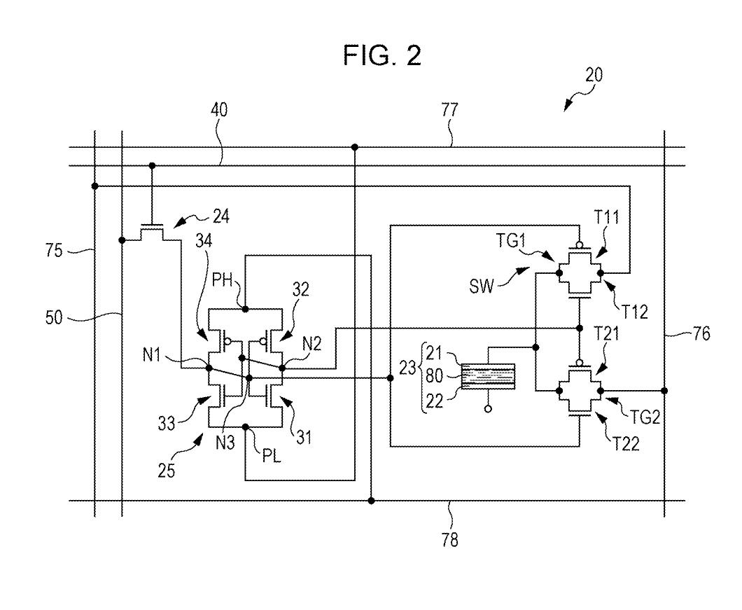

FIG. 2 is a diagram illustrating a circuit configuration of a pixel 20.

As illustrated in FIG. 2, the pixel 20 includes a pixel switching element 24, a latch circuit (memory circuit) 25, a switch circuit SW for potential control, and an electrophoretic element 23. The electrophoretic element 23 includes a pixel electrode 21, a counter electrode 22, and an electrophoretic layer 80 disposed between the pixel electrode 21 and the counter electrode 22. The switch circuit SW includes transfer gates TG1 and TG2.

The pixel switching element 24 is an N type transistor of a field effect type. A gate terminal of the pixel switching element 24 is connected to the scan line 40, a source terminal of the pixel switching element 24 is connected to the data line 50, and a drain terminal of the pixel switching element 24 is connected to an input terminal N1 of the latch circuit 25. In a period when a selection signal is input from the scan line drive circuit 60 via the scan line 40, the pixel switching element 24 connects the data line 50 to the latch circuit 25, and thereby an image signal that is input from the data line drive circuit 70 via the data line 50 is input to the latch circuit 25.

The latch circuit 25 is configured with two P type transistors 32 and 34, and two N type transistors 31 and 33. A high potential power supply line 78 is connected to a source side of the P type transistors 32 and 34, and a low potential power supply line 77 is connected to a source side of the N type transistors 31 and 33. Thus, the source side of the P type transistors 32 and 34 becomes a high potential power supply terminal PH of the latch circuit 25, and the source side of the N type transistors 31 and 33 becomes a low potential power supply terminal PL of the latch circuit 25.

The latch circuit 25 includes an input terminal N1 that is connected to a drain side of the pixel switching element 24, and a first output terminal N2 and a second output terminal N3 that are connected to the switch circuit SW.

A drain side of the P type transistor 34 and a drain side of the N type transistor 33 in the latch circuit 25 function as the input terminal N1 of the latch circuit 25. The input terminal N1 is connected to the drain side of the pixel switching element 24, and is connected to the second output terminal N3 (a gate portion of the P type transistor 32 and a gate portion of the N type transistor 31) of the latch circuit 25.

Furthermore, the second output terminal N3 is connected to the transfer gates TG1 and TG2.

A drain side of the P type transistor 32 and a drain side of the N type transistor 31 in the latch circuit 25 function as the first output terminal N2 of the latch circuit 25.

The first output terminal N2 is connected to a gate portion of the P type transistor 34 and a gate portion of the N type transistor 33, and is connected to the transfer gates TG1 and TG2.

The latch circuit 25 is a circuit corresponding to a static random access memory (SRAM) cell. The latch circuit 25 is used to retain an image signal transmitted from the pixel switching element 24, and to input the image signal to the switch circuit SW. Based on the image signal that is input from the latch circuit 25, the switch circuit SW selects any one of the first control line 75 and the second control line 76, and functions as a selector that connects the selected control line to the pixel electrode 21. At this time, according to a level of the image signal, only one of the transfer gates TG1 and TG2 operates.

The transfer gate TG1 includes a P type transistor T11 of a field effect type, and an N type transistor T12 of a field effect type. A source terminal of the P type transistor T11 and a source terminal of the N type transistor T12 are connected to each other, and the sources are connected to the first control line 75. A drain terminal of the P type transistor T11 and a drain terminal of the N type transistor T12 are connected to each other, and the drains are connected to the pixel electrode 21. A gate terminal of the P type transistor T11 is connected to the input terminal N1 of the latch circuit 25, and a gate of the N type transistor T12 is connected to the first output terminal N2 of the latch circuit 25.

The transfer gate TG2 includes a P type transistor T21 of a field effect type, and an N type transistor T22 of a field effect type. A source terminal of the P type transistor T21 and a source terminal of the N type transistor T22 are connected to each other, and the sources are connected to the second control line 76. A drain terminal of the P type transistor T21 and a drain terminal of the N type transistor T22 are connected to each other, and the drains are connected to the pixel electrode 21.

In addition, a gate terminal of the P type transistor T21 is connected to a gate terminal of the N type transistor T12 of the transfer gate TG1, and is connected to the output terminal N2 of the latch circuit 25. A gate terminal of the N type transistor T22 is connected to the gate terminal of the P type transistor T11 of the transfer gate TG1, and is connected to the input terminal N1 of the latch circuit 25. In addition, the first control line 75 and the second control line 76 are disposed in parallel with each pixel 20.

For example, if a low level (L: potential close to a potential of the low potential power supply line 77) is input to the input terminal N1 of the latch circuit 25 as an image signal, a high level (H: potential close to a potential of the high potential power supply line 78) is output from the first output terminal N2, and thus the N type transistor T12 that is connected to the first output terminal N2 operates, and in addition, the P type transistor T11 that is connected to the second output terminal N3 (input terminal N1) operates, and the transfer gate TG1 is driven. Thus, the first control line 75 is electrically connected to the pixel electrode 21.

Meanwhile, if a high level (H) is input to the input terminal N1 of the latch circuit 25 as the image signal, a low level (L) is output from the first output terminal N2, and thus the P type transistor T21 that is connected to the first output terminal N2 operates, and in addition, the N type transistor T22 that is connected to the second output terminal N3 (input terminal N1) operates, and the transfer gate TG2 is driven. Thus, the second control line 76 is electrically connected to the pixel electrode 21.

Then, via the transfer gate that operates, the first control line 75 or the second control line 76 is electrically connected to the pixel electrode 21, and a potential is input to the pixel electrode 21.

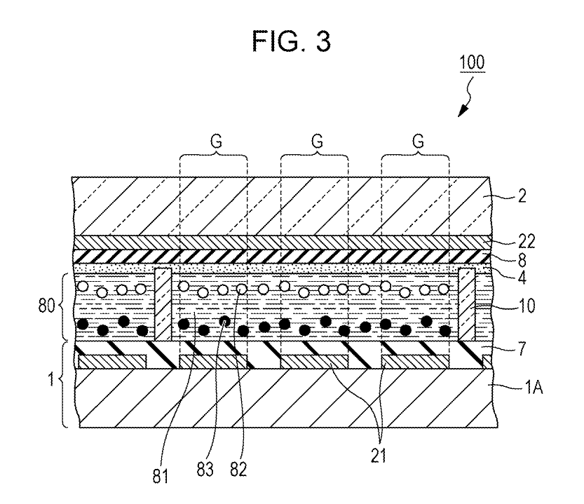

FIG. 3 is a cross-sectional diagram illustrating a schematic configuration of the electrophoretic display device 100 according to the present embodiment. The electrophoretic display device 100 illustrated in FIG. 3 includes an element substrate 1, a counter substrate 2, and an electrophoretic layer 80 disposed between the element substrate 1 and the counter substrate 2.

The element substrate 1 includes a base material 1A, a pixel electrode 21 that is provided on an electrophoretic layer 11 side of the base material 1A, and a first insulating film 7 that covers the pixel electrode 21. The base material 1A is a substrate that is formed of glass, plastic, or the like, is disposed in a side opposite to an image display surface, and thus, may not be transparent. The pixel electrode 21 is an electrode that is formed by a Cu foil on which nickel plating and gold plating are sequentially laminated, Al, indium tin oxide (ITO), or the like. While not being illustrated, the scan line 40, the data line 50, the pixel switching element 24, and the like are formed between the pixel electrode 21 and the base material 1A.

The counter substrate 2 is configured by a transparent base material such as, glass, or plastic, and is disposed on an image display side. The counter electrode 22 in a planar form that opposes a plurality of pixel electrodes 21 is formed on the electrophoretic layer 80 of the counter substrate 2. An entire surface of the counter electrode 22 is covered with a second insulating film 8. The counter electrode 22 is a transparent electrode that is formed of MgAg, ITO, indium zinc oxide (IZO), or the like.

The electrophoretic layer 80 is filled into multiple spaces (areas) partitioned by the first insulating film 7 which is provided in an inner side of the element substrate 1, a second insulating film 8 which is provided in an inner side of the counter substrate 2, and the partition walls 10 that are disposed between the first insulating film 7 and the second insulating film 8. In the present embodiment, the partition walls 10 are those corresponding to a size for partitioning the plurality (in the present embodiment, for example, three) of pixels 20, and are composed of a light-transmissive material (acrylic, epoxy resin, or the like).

A thickness of the partition wall 10 is, for example, 30 μm. In addition, a bonding layer 4 is provided between an upper portion of the partition wall 10 and the second insulating film 8. The bonding layer 4 is used for bonding the counter substrate 2 to the element substrate 1 on which the partition walls 10 are formed. The bonding layer 4 is composed of, for example, a light-transmissive resin, and an upper portion of the partition wall 10 cuts into the bonding layer 4. It is preferable that the bonding layer 4 have a thickness of a degree that does not interfere with an electric field, for example, approximately 2 μm to 6 μm. In addition, it is preferable that an amount of the partition wall 10 cutting into the bonding layer 4 be 0.5 μm to 1 μm.

The electrophoretic layer 80 is composed of a plurality of electrophoretic particles that are dispersed in a dispersion medium 81. In the present embodiment, for example, the electrophoretic particles are composed of white particles 82 and black particles 83.

The white particles 82 are particles (polymer or colloid) composed of white pigment, such as titanium oxide, zinc oxide, or antimony trioxide, and are negatively charged, for example. The black particles 83 are particles (polymer or colloid) composed of black pigment, such as aniline black or carbon black, and are positively charged. As necessary, an electrolyte, a surface active agent, a metal soap, a resin, rubber, oil, varnish, a charge control agent composed of particles such as compound, a titanium coupling agent, an aluminum coupling agent, a dispersing agent such as a silane coupling agent, a lubricating agent, a stabilizer, or the like can be added to the pigments.

In addition, instead of the white particles 82 and the black particles 83, pigments of a color, such as red, green, or blue may be used. According to the composition, it is possible to provide the electrophoretic display device 100 that can display a color such as red, green, blue, or the like.

As the dispersion medium 81, water, an alcohol solvent (methanol, ethanol, isopropanol, butanol, octanol, and methyl cellosolve, or the like), an ester (ethyl acetate, butyl acetate, or the like), a ketone (acetone, methyl ethyl ketone, methyl isobutyl ketone, or the like), an aliphatic hydrocarbon (pentane, hexane, octane, or the like), an alicyclic hydrocarbon (cyclohexane, methylcyclohexane, or the like), an aromatic hydrocarbon (benzene, toluene, xylene, benzene with a long chain alkyl group (hexylbenzene, heptylbenzene, octylbenzene, nonylbenzene, decylbenzene, undecylbenzene, dodecylbenzene, tridecylbenzene, tetradecylbenzene, or the like)), halogenated hydrocarbons (methylene chloride, chloroform, carbon tetrachloride, 1,2-dichloroethane, or the like), silicone oil, or the like can be exemplified, and other oils may be used. These materials can be used alone or as a mixture, and furthermore surface active agent such as carboxylic acid salt, or the like may be blended in.

For example, in the electrophoretic display device 100, based on such a configuration, if a voltage is input between the pixel electrode 21 and the counter electrode 22, the electrophoretic particles (white particles 82 and black particles 83) undergo electrophoresis toward one of the electrodes (pixel electrode 21, counter electrode 22) according to an electric field occurring between the pixel electrode 21 and the counter electrode 22, as will be described.

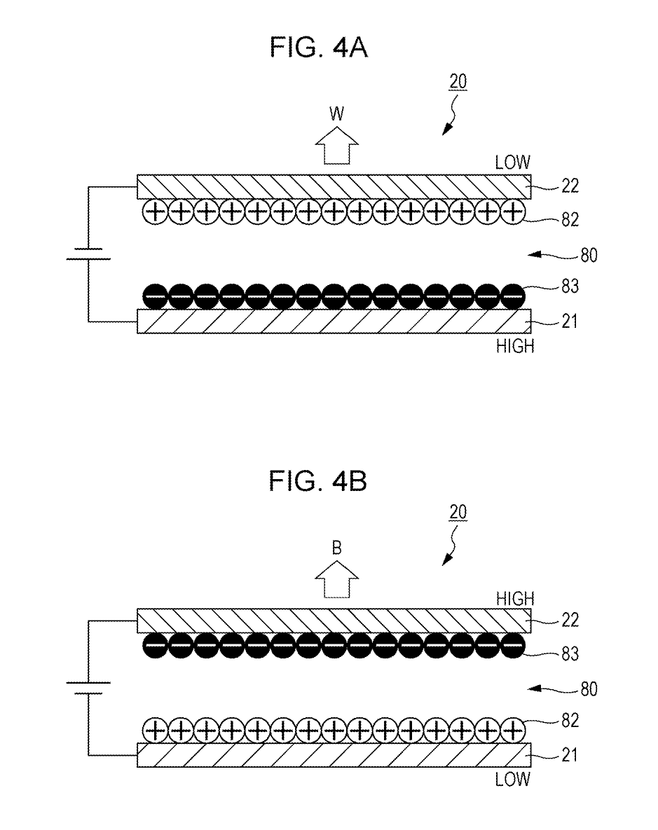

FIGS. 4A and 4B are operation explanatory diagrams of the electrophoretic element (white particles 82 and black particles 83). FIG. 4A illustrates a case where the pixel 20 performs a white display, and FIG. 4B illustrates a case where the pixel 20 performs a black display. In the present embodiment, it is assumed that the white particles 82 are positively charged, and the black particles 83 are negatively charged.

In a case of the white display illustrated in FIG. 4A, the counter electrode 22 maintains a relatively low potential, and the pixel electrode 21 maintains a relatively high potential. As a result, while the white particles 82 that are positively charged are attracted to the counter electrode 22, the black particles 83 that are negatively charged are attracted to the pixel electrode 21. As a result, if the pixel 20 is viewed from the counter electrode 22 that is a display surface side, white (W) is recognized.

Meanwhile, in a case of the black display illustrated in FIG. 4B, the counter electrode 22 maintains a relatively high potential, and the pixel electrode 21 maintains a relatively low potential. As a result, while the black particles 83 that are negatively charged are attracted to the counter electrode 22, the white particles 82 that are positively charged are attracted to the pixel electrode 21. As a result, if the pixel is viewed from the counter electrode 22, black (B) is recognized.

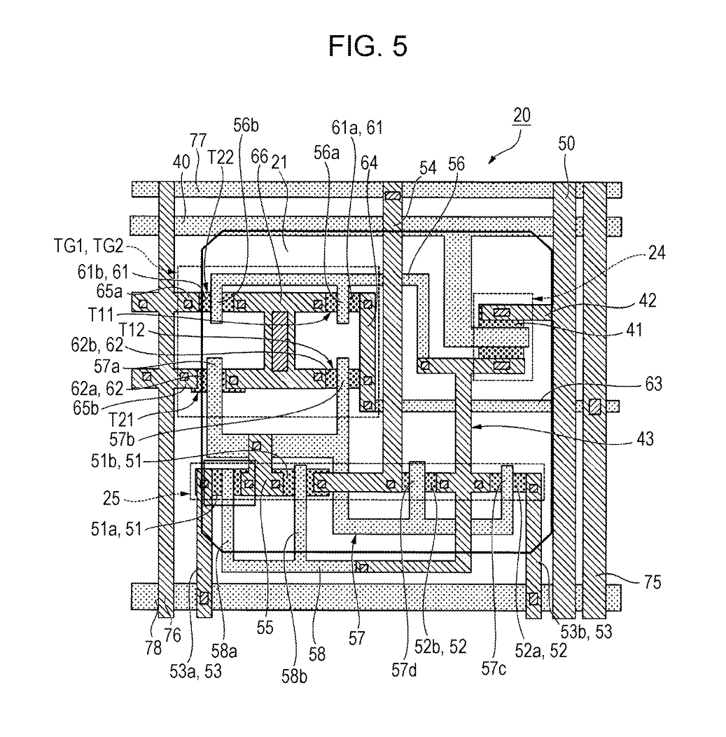

FIG. 5 is a plan view specifically illustrating a circuit configuration of one pixel 20 in the electrophoretic display device 100 according to the present embodiment.

The pixel 20 is formed of a laminated structure. As illustrated in FIG. 5, a semiconductor layer is provided on a bottom layer as a first layer. In addition, various wires are formed on a second layer that is a layer above the first layer, and on a third layer that is a layer above the second layer. In addition, the pixel electrode 21 is formed on a fourth layer. Each layer is insulated by an insulating layer that is not illustrated.

Firstly, wires that are provided on the outer periphery of the pixel 20 will be described. The scan line 40, the data line 50, the high potential power supply line 78, the low potential power supply line 77, the first control line 75, and the second control line 76 are provided on the outer periphery of the pixel 20. The wires are formed over the plurality of pixels 20. The first control line 75 and the second control line 76 respectively have at least a portion that does not overlap the partition wall 10 in a planar view. Of these, the scan line 40 is orthogonal to the data line 50 on an upper right corner of the pixel 20 in FIG. 5.

In addition, the high potential power supply line 78 and the low potential power supply line 77 are disposed so as to be opposed to each other above and below the pixel 20 in FIG. 5. The first control line 75 and the second control line 76 are disposed so as to be opposed to each other on the left and right of the pixel 20 in FIG. 5. Of the wires, the scan line 40, the low potential power supply line 77, and the high potential power supply line 78 are formed on the same layer (second layer), and the data line 50, the first control line 75, and the second control line 76 are formed on the same layer that is a higher layer (third layer) than the second layer.

Secondly, configurations of the wires and semiconductor layers that are provided within the pixel 20 will be described. Semiconductor layers 41, 51, 52, 61, and 62 are formed on the first layer F1 that is a bottom layer of the pixel 20. All the semiconductor layers are composed of a semiconductor material such as silicon. In addition, of course, it does not matter if each semiconductor layer is composed of other materials.

In the present embodiment, the semiconductor layer 51 includes a first semiconductor layer 51a and a second semiconductor layer 51b. The semiconductor layer 52 includes a first semiconductor layer 52a and a second semiconductor layer 52b. The semiconductor layer 61 includes a first semiconductor layer 61a and a second semiconductor layer 61b. The semiconductor layer 62 includes a first semiconductor layer 62a and a second semiconductor layer 62b. The semiconductor layers 41, 51, 52, 61, and 62 are formed in island shapes that are separated from each other.

The wires 56, 57, 58, and 63 are formed on the second layer that is a layer above the first layer. The wires are composed of a metal with high conductivity such as copper, aluminum, or silver.

The wire 56 includes a branch portion 56a that is provided so as to overlap the first semiconductor layer 61a in a planar view, and a branch portion 56b that is provided so as to overlap the second semiconductor layer 61b in a planar view. The P type transistor T11 is configured by the first semiconductor layer 61a, the branch portion 56a, and a gate insulating layer that is disposed between the first semiconductor layer 61a and the branch portion 56a, and the N type transistor T22 is configured by the second semiconductor layer 61b, the branch portion 56b, and a gate insulating layer that is disposed between the second semiconductor layer 61b and the branch portion 56b.

The wire 57 includes a branch portion 57a that is provided so as to overlap the first semiconductor layer 62a in a planar view, a branch portion 57b that is provided so as to overlap the second semiconductor layer 62b in a planar view, a branch portion 57c that is provided so as to overlap the first semiconductor layer 52a in a planar view, and a branch portion 57d that is provided so as to overlap the second semiconductor layer 52b in a planar view. The P type transistor T21 is configured by the first semiconductor layer 62a, the branch portion 57a, and a gate insulating layer that is disposed between the first semiconductor layer 62a and the branch portion 57a, and the N type transistor T12 is configured by the second semiconductor layer 62b, the branch portion 57b, and a gate insulating layer that is disposed between the second semiconductor layer 62b and the branch portion 57b.

The wire 58 includes a branch portion 58a that is provided so as to overlap the first semiconductor layer 51a in a planar view, and a branch portion 58b that is provided so as to overlap the second semiconductor layer 51b in a planar view. The latch circuit 25 is configured with the semiconductor layers 51 and 52, and the wires 57 and 58.

The wire 63 is configured to include a portion of the wire, in such a manner that the first control line 75 and the transistors T11 and T12 are connected to each other. The wire 63 is connected to the first control line 75 via a contact hole.

The wires 42, 43, 53, 54, 55, 64, 65, and 66 are formed on the third layer that is a layer above the second layer. Such wires are the same as the wires that are formed on the second layer, and for example, are composed of a metal with high conductivity such as copper, aluminum, or silver.

The wire 42 is a portion that protrudes in a left direction in FIG. 5 toward an inside of the pixel 20 from the data line 50, and is connected to one end portion of the semiconductor layer 41 via a contact hole.

The wire 43 is connected to the other end portion of the semiconductor layer 41 and an end portion of the wire 58 via a contact hole. In addition, the wire 43 is connected to the other end portion of the semiconductor layer 41 and the wire 56 via a contact hole.

The wire 53 includes a wire 53a that connects the high potential power supply line 78 to the first semiconductor layer 51a, and a wire 53b that connects the high potential power supply line 78 to the first semiconductor layer 52a. The wire 53 is connected to the first semiconductor layers 51a and 52a via a contact hole.

The wire 54 is a wire that is connected to the low potential power supply line 77, the second semiconductor layer 52b, and the second semiconductor layer 51b. The wire 54 is connected to the second semiconductor layers 51b and 52b via a contact hole.

The wire 55 is connected to the first semiconductor layer 51a, the second semiconductor layer 51b, and the wire 57 via contact holes, respectively.

The wire 64 is a wire that is connected to the first semiconductor layer 61a, the second semiconductor layer 62b, and the wire 63. The wire 64 is connected to the first semiconductor layer 61a, the second semiconductor layer 62b, and the wire 63 via contact holes, respectively. The wire 65 includes a wire 65a that is connected to the second control line 76 and the transistor (N type transistor) T22, and a wire 65b that is connected to the second control line 76 and the transistor (P type transistor) T21. The wires 65a and 65b are connected to the second semiconductor layer 61b and the first semiconductor layer 62a via contact holes, respectively.

The wire 66 is connected to the first semiconductor layers 61a and 62a, and the second semiconductor layers 61b and 62b via contact holes, respectively. Furthermore, the wire 66 is connected to the pixel electrode 21 that is formed on an upper layer (fifth layer) via a contact hole.

Each layer is formed in this way, and thereby the transfer gates TG1 and TG2 are configured by the semiconductor layers 61 and 62, the wires 56, 57, 64, and 66, and an insulating layer (not illustrated) between the first layer and the second layer.

In addition, a portion that in a planar view overlaps a portion of the scan line 40 in the semiconductor layer 41 becomes a channel region, a portion that is connected to the data line 50 via the wire 42 becomes a source region, and a portion that is connected to the wire 43 becomes a drain region. A portion (extending portion) that in a planar view overlaps the semiconductor layer 41 in the scan line 40 configures the gate electrode of the pixel switching element 24.

In addition, the latch circuit 25 is configured by using the semiconductor layers 51 and 52, and the wires 53, 55, 57, 58, and 57 as a main body. While not being illustrated, the N type transistor 31 and the P type transistor 32 of the latch circuit 25 are configured by the semiconductor layer 51, and the N type transistor 33 and the P type transistor 34 of the latch circuit 25 are configured by the semiconductor layer 52.

The P type transistor T11 of a field effect type is configured by using the first semiconductor layer 61a as a main body, and the N type transistor T12 of a field effect type is configured by using the second semiconductor layer 62b as a main body. The N type transistor T22 of a field effect type is configured by using the second semiconductor layer 61b as a main body, and the P type transistor T21 of a field effect type is configured by using the first semiconductor layer 62a as a main body. That is, the transfer gates TG1 and TG2 are configured by the first semiconductor layer 61a, the second semiconductor layer 62b, and the wires 56, 57, 64, and 66.

When the pixel 20 is formed, the first layer to the fourth layer may be sequentially laminated.

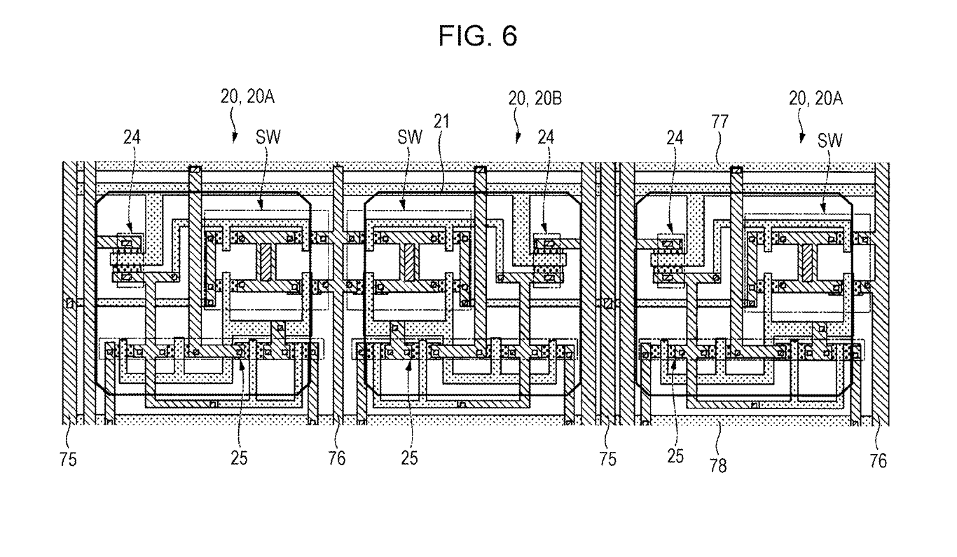

FIG. 6 is a plan view specifically illustrating a configuration of three pixels 20 in the electrophoretic display device 100 according to the present embodiment.

As illustrated in FIG. 6, the present embodiment employs a configuration of using the second control line 76 commonly for a pixel 20A and a pixel 20B that are adjacent to each other. In the configuration illustrated in FIG. 6, a structure of the pixel 20A and a structure of the pixel 20B are in a relationship of line symmetry with respect to the second control line 76. By disposing in this way, it is possible to reduce the number of second control lines 76, without a large change in an actual disposal of the wires in the pixel. For this reason, it is possible to secure a wide space between the pixel 20A and the pixel 20B that are adjacent to each other, and to have a margin in a distance between wires formed in the pixel 20A and the pixel 20B.

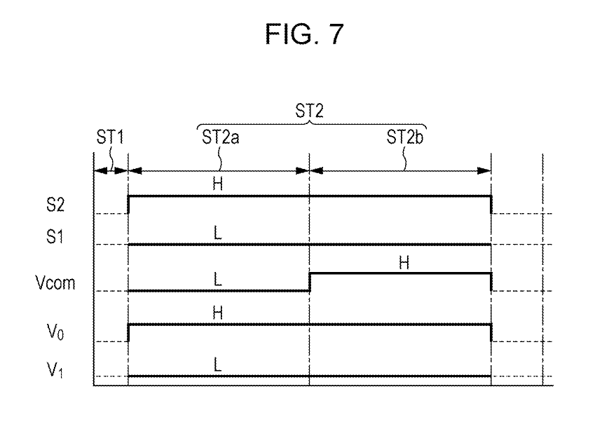

Subsequently, by focusing on one pixel 20 of the electrophoretic display device 100, driving of the pixel 20 will be described. FIG. 7 is a timing chart when one pixel 20 is driven.

As described in FIG. 7, each pixel 20 in the electrophoretic display device 100 generates an image by transition from an image signal input period ST1 to an image writing period ST2.

In the image signal input period ST1, image data is input to the latch circuit 25 from the data line 50. Specifically, in the pixel 20 having the above-described configuration, if the image data with a low level is input to the latch circuit 25 from the data line 50 via the pixel switching element 24, a terminal N1 of the latch circuit 25 goes to a low level, as described above.

Then, the transfer gate TG1 is turned on, and the pixel electrode 21 is electrically connected to the first control line 75. Then, a potential corresponding to the first control line 75 can be input to the pixel electrode 21. That is, a potential (L) with a low level, for example, 0 V is input to the pixel electrode 21 from the first control line 75 as a control signal S1.

Meanwhile, if image data with a high level is input to the latch circuit 25 from the data line 50 via the pixel switching element 24, the transfer gate TG2 is turned on, and the pixel electrode 21 is electrically connected to the second control line 76. Then, a potential corresponding to the second control line 76 can be input to the pixel electrode 21. That is, a potential (H) with a high level, for example, 15 V is input to the pixel electrode 21 from the second control line 76 as a control signal S2.

Subsequently, the image writing period ST2 will be described. As illustrated in FIG. 7, the image writing period ST2 includes a first half portion ST2a and a second half portion ST2b.

In the first half portion ST2a of the image writing period ST2, a potential Vcom that is, for example, 0 V, and corresponds to a signal with a low level is input to the counter electrode 22. The control signal S1 (here, L: 0 V) is input to the first control line 75, and the control signal S2 (here, H: 15 V) is input to the second control line. In this case, a potential difference does not occur between the pixel electrode 21 to which the potential (L) of 0 V is input from the first control line 75, and the counter electrode 22. For this reason, the electrophoretic particles (white particles 82 and black particles 83) do not move.

Meanwhile, since the pixel electrode 21 to which a potential (H) of 15 V is input from the second control line 76 has a potential difference of 15 V with respect to the counter electrode 22, the white particles 82 that are positively charged move to the counter electrode 22 side, the black particles 83 that are negatively charged move to the pixel electrode 21 side, and thus if a pixel is viewed from the counter electrode 22 that is a display surface, white (W) is recognized (refer to FIG. 4A).

In the second half portion ST2b of the image writing period ST2, the potential Vcom that is, for example, 15 V, and corresponds to a signal with a high level is input to the counter electrode 22. In this case, a potential difference does not occur between the pixel electrode 21 to which the potential (H) of 15 V is input from the second control line 76, and the counter electrode 22. Meanwhile, since the pixel electrode 21 to which the potential (L) of 0 V is input from the first control line 75 has a potential difference of −15 V with respect to the counter electrode 22, the white particles 82 that are positively charged move to the pixel electrode 21 side, the black particles 83 that are negatively charged move to the counter electrode 22 side, and thus if a pixel is viewed from the counter electrode 22 that is a display surface, black (B) is recognized (refer to FIG. 4B).

As described above, the pixel 20 having the pixel electrode 21 to which the potential (L) of 0 V is input from the first control line 75 is changed to black, and the pixel 20 having the pixel electrode 21 to which the potential (H) of 15 V is input from the second control line 76 is changed to white. In FIG. 7, a potential that is input to the pixel electrode 21 of the pixel 20 in which the image signal corresponds to L (0) is denoted by V₀, and a potential that is input to the pixel electrode 21 of the pixel 20 in which the image signal corresponds to H (1) is denoted by V₁. Thus, an image signal L is set in the pixel 20 that performs black display, and an image signal H is set in the pixel 20 that performs white display.

However, the first control line 75 and the second control line 76 are formed in common over the plurality of pixels 20. For this reason, during the image writing period ST2, the potential (L) of 0 V is usually input to the first control line 75, and the potential (L) of 15 V is usually input to the second control line 76.

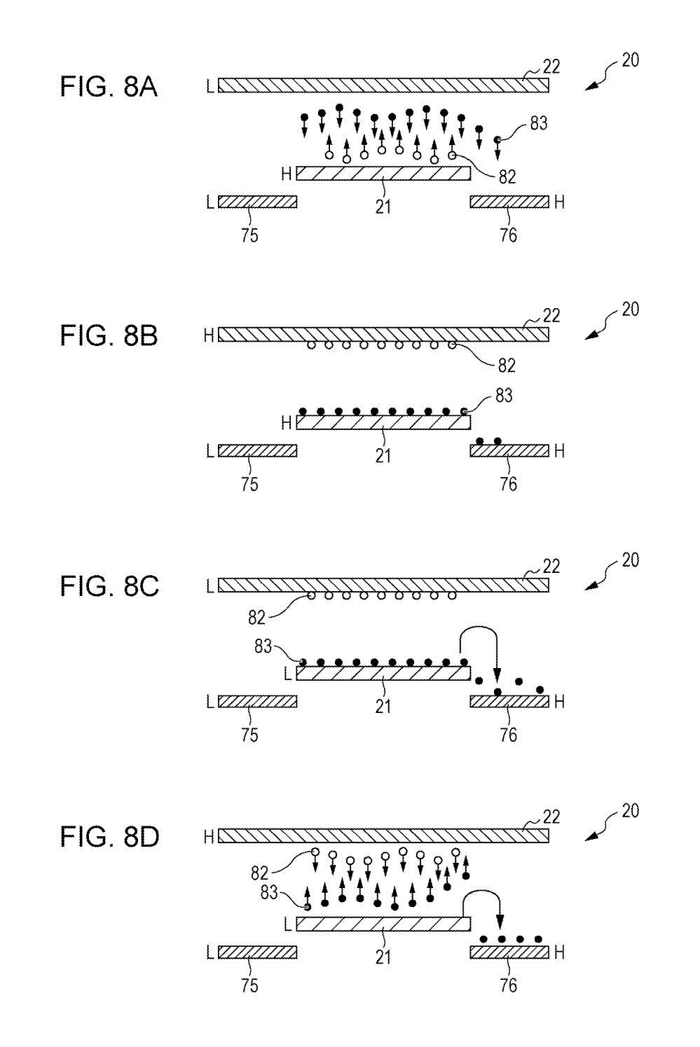

At this time, phenomena illustrated in FIGS. 8A to 8D can occur in each pixel 20. FIGS. 8A and 8D respectively illustrate a cross section per one pixel 20, and movement of the white particles 82 and the black particles 83. In addition, for brief illustration, FIGS. 8A to 8D only illustrate the pixel electrode 21, the counter electrode 22, the first control line 75, and the second control line 76.

When the black display is switched to the white display in the one pixel 20, FIG. 8A corresponds to the first half portion ST2a of the image writing period ST2, and FIG. 8B corresponds to the second half portion ST2b of the image writing period ST2 following FIG. 8A. In addition, when the white display is switched to the black display in the one pixel 20, FIG. 8C corresponds to the first half portion ST2a of the image writing period ST2, and FIG. 8D corresponds to the second half portion ST2b of the image writing period ST2 following FIG. 8C.

When the pixel 20 is changed from the black display to the white display, in the first half portion ST2a of the image writing period ST2, a potential of 15 V (H) is input to the pixel electrode 21, and a potential of 0 V (L) is input to the counter electrode 22. At this time, as illustrated in FIG. 8A, the black particles 83 are attracted toward the pixel electrode 21 that has a relatively high potential with respect to the counter electrode 22, and the second control line 76 (the same potential as the pixel electrode 21). In addition, the white particles 82 are attracted to the counter electrode 22.

In addition, in the second half portion ST2b of the image writing period ST2, since the potential of 15 V is input to the pixel electrode 21 and the potential Vcom of 15 V (H) is input to the counter electrode 22, the counter electrode 22, the pixel electrode 21, and the second control line 76 have the same potential. Thus, an electric field is not generated between the pixel electrode 21 and the second control line 76, and the counter electrode 22, and as illustrated in FIG. 8B, the electrophoretic particles (white particle 82 and black particles 83) do not move from the top of the pixel electrode 21, the counter electrode 22, and the second control line 76.

When the pixel 20 is changed from the white display to the black display, in the first half portion ST2a of the image writing period ST2, a potential of 0 V (L) is input to the pixel electrode 21 from the first control line 75, and a potential of 0 V (L) is input to the counter electrode 22. At this time, since the potential of the second control line 76 is 15 V (H), the black particles 83 are attracted toward the second control line 76 that has a relatively high potential with respect to the counter electrode 22, as illustrated in FIG. 8C.

In addition, in the second half portion ST2b of the image writing period ST2, the potential Vcom of 15 V (H) is input to the counter electrode 22. For this reason, the second control line 76 and the counter electrode 22 have a relatively high potential with respect to the pixel electrode 21. Thus, as illustrated in FIG. 8D, the black particles 83 that are negatively charged move toward the counter electrode 22 from the top of the pixel electrode 21. In addition, the black particles 83 also move toward the second control line 76 side from the top of the pixel electrode 21. In addition, the white particles 82 that are positively charged move toward the counter electrode 22.

That is, the black particles 83 accumulate in a portion (gap between the pixel electrodes 21) that overlaps the second control line 76 in a planar view. Since the second control line 76 can structurally take only a potential of 0 V (for example, a period at the time of power-off or the like, other than the image writing period ST) or +15 V, the accumulated black particles 83 continue to stay over the second control line 76 or near the second control line 76. In an area (area in which the second control line 76 and the partition wall 10 overlap each other in a planar view) in which the partition wall 10 is disposed between the second control line 76 and the counter electrode 22, such behavior is suppressed to some extent, but in an area (that is, a case where the area has a portion in which the second control line 76 and the partition wall 10 do not overlap each other in a planar view) in which the partition wall 10 is not disposed between the second control line 76 and the counter electrode 22, the electrophoretic particles accumulate significantly.

For this reason, if an amount of accumulation of the black particles 83 exceeds a predetermined threshold, the number of particles that can contribute to display is decreased, and in a case of display unevenness, or at the worst, a problem of non-display occurs. In addition, in FIGS. 8A to 8D, while not being illustrated for brief description, the same phenomenon as in the second control line 76 occurs also in the first control line 75, and accumulation of the white particles 82 occurs with time.

In the present embodiment, in order to prevent the electrophoretic particles (white particles 82 and black particles 83) from accumulating, when an image that is displayed on the display unit 3 is rewritten, a control (first control operation) that mutually inverts a control signal which is output from the control line drive circuit 30 by the controller 200, between the first control line 75 and the second control line 76, and a control (second control operation) that supplies inversion image data which is obtained by inverting the image data which is supplied from a higher-level device to the data line drive circuit 70, are performed.

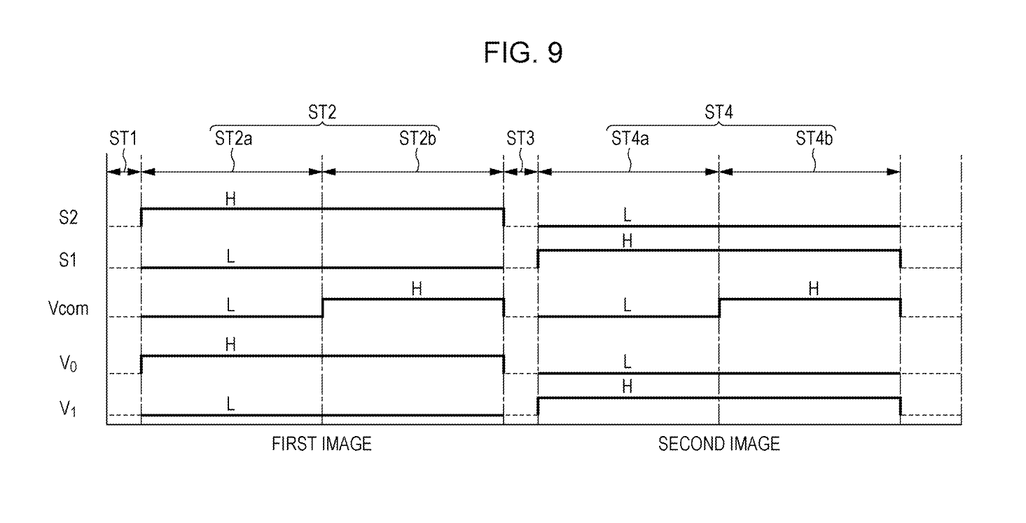

FIG. 9 is a timing chart illustrating signals that are changed by a control of the controller 200. FIG. 9 corresponds to a case where an image of the display unit 3 is rewritten to a second image from a first image. In FIG. 9, an image signal input period ST1 corresponds to a signal input operation of the first image, an image writing period ST2 corresponds to a writing operation of the first image, an image signal input period ST3 corresponds to a signal input operation of the second image, and an image writing period ST4 corresponds to a writing operation of the second image.

As illustrated in FIG. 9, when the image of the display unit 3 is switched (rewritten) from the first image to the second image, that is, when the image writing period ST2 is changed to the image writing period ST4, the first control operation and the second control operation are performed.

In the first control operation, the controller 200 controls driving of the control line drive circuit 30, in such a manner that, in the image writing period ST2, a control signal S1 which is input to the first control line 75 goes to a low level (L: 0 V), a control signal S2 which is input to the second control line 76 goes to a high level (H: 15 V), and in the image writing period ST4, the signals replace each other, and thereby the control signal S1 which is input to the first control line 75 goes to a high level, and the control signal S2 which is input to the second control line 76 goes to a low level.

Accordingly, as illustrated in FIG. 9, in the image writing period ST4, a potential (H) of 15 V is input to the pixel electrode 21 by the control signal S1 from the first control line 75, and a potential (L) of 0 V is input to the pixel electrode 21 by the control signal S2 from the second control line 76.

Here, in the image writing period ST2, with regard to the image data, a potential input to the pixel electrode 21 corresponding to when the pixel 20 is changed to black is 0 V (L), and a potential input to the pixel electrode 21 corresponding to when the pixel 20 is changed to white is 15 V (H). For this reason, if the image data is input as it is in the image signal input period ST3, a color that is displayed on the pixel 20 is inverted from white to black and vice versa, in the image writing period ST4.

In contrast to this, in the present embodiment, the controller 200 generates inversion image data that is obtained by inverting the image data corresponding to the second image, and inputs the inversion image data to the data line 50 by the data line drive circuit 70, as a second control operation. That is, the controller 200 uses black display data (1 (H)) and white display data (0 (L)), instead of using black display data (0 (L)) and white display data (1 (H)), as the image data in the image writing period ST2.

Accordingly, in the image signal input period ST3, inversion image data that is obtained by inverting white and black information is input to each data line 50. Thus, in the image signal input period ST3, with regard to the inversion image data, the potential input to the pixel electrode 21 corresponding to when the pixel 20 is changed to black is 15 V (H), and the potential input to the pixel electrode 21 corresponding to when the pixel 20 is changed to white is 0 V (L). Accordingly, the second image that is displayed on the pixel 20 in the image writing period ST4 is not changed from white to black or vice versa, and becomes good in the same manner as in the image writing period ST2.

As described above, in the present embodiment, the first control line 75 and the second control line 76 can undergo binary inversion (0 V or 15 V). For this reason, since the first control line 75 and the second control line 76 have a relative relationship of a potential with regard to the pixel electrode 21 which changes, a repulsive force can be generated with respect to the black particles 83 that accumulate in a portion corresponding to the second control line 76, as illustrated in FIG. 8B. Thus, it is possible to release the accumulated black particles 83.

Thus, since the electrophoretic particles are unevenly distributed on the portion corresponding to the first control line 75 and the second control line 76 and do not stay there, it is possible to obtain a good display quality without display unevenness.

In addition, in the description of FIG. 9, a case of different gradations (white image from black image) when data is rewritten from the first image to the second image is used as an example, but the same gradations (black image from black image or white image from white image) may be used when data is rewritten from the first image to the second image.

In addition, it is desirable that the controller 200 perform inversion of potentials input to the first control line 75 and the second control line 76 and an inversion control of the image data, at least for a several-frame period, preferably for a one frame period. According to this, it is possible to perform a relatively frequent ejection of the electrophoretic particles. Thus, it is possible to reliably prevent the electrophoretic particles from accumulating and to retain a good display quality. Here, an image signal is input to the pixel 20 through the scan line drive circuit 60 and the data line drive circuit 70, and a period in which all the scan lines 40 are sequentially selected once becomes one frame (one frame period).

In addition, the inversion operation need not necessarily be performed, correctly, and alternately for each image writing. For example, an inversion operation may be selectively performed for each of predetermined timings (for each time or for each frame). In addition, a higher-level device that drives the electrophoretic display device 100 does not need to remember which potential is input to the previous electrophoretic display device when power is off, or the like.

### Second Embodiment

Subsequently, an electrophoretic display device according to the second embodiment will be described. In the first embodiment, a case where, using a control of the controller 200, the inversion operation (first control operation) of the signal of the first control line 75 and the second control line 76, and the inversion operation (second control operation) of the image data are performed, is used as an example. The present embodiment is different from the first embodiment in that, using a circuit, the inversion operation of the signal of the first control line 75 and the second control line 76, and the inversion operation of the image data are performed. For this reason, hereinafter, a configuration of the circuit will be mainly described, the same reference numerals and symbols are attached to the same members and configurations as those of the first embodiment, and detailed description thereof will be omitted or simplified.

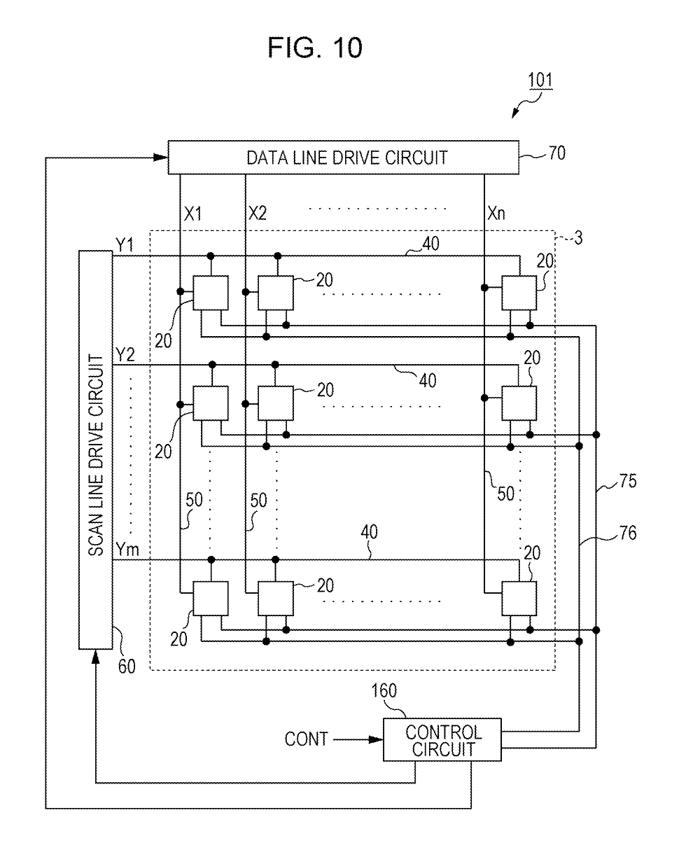

FIG. 10 is a plan view illustrating a schematic configuration of an electrophoretic display device 101 according to the second embodiment. As illustrated in FIG. 10, the electrophoretic display device 101 further includes a control circuit 160 for performing the inversion operation of the signal of the first control line 75 and the second control line 76, and the inversion operation of the image data, in addition to the display unit 3 in which the plurality of pixels 20 are arranged, the scan line drive circuit 60, and the data line drive circuit 70.

In the present embodiment, the control circuit 160 receives the image data or the sync signal from the higher-level device via the controller (CONT). The control circuit 160 performs the control that the controller 200 performs in the first embodiment, that is, the inversion operation of the signal of the first control line 75 and the second control line 76, and the inversion operation of the image data.

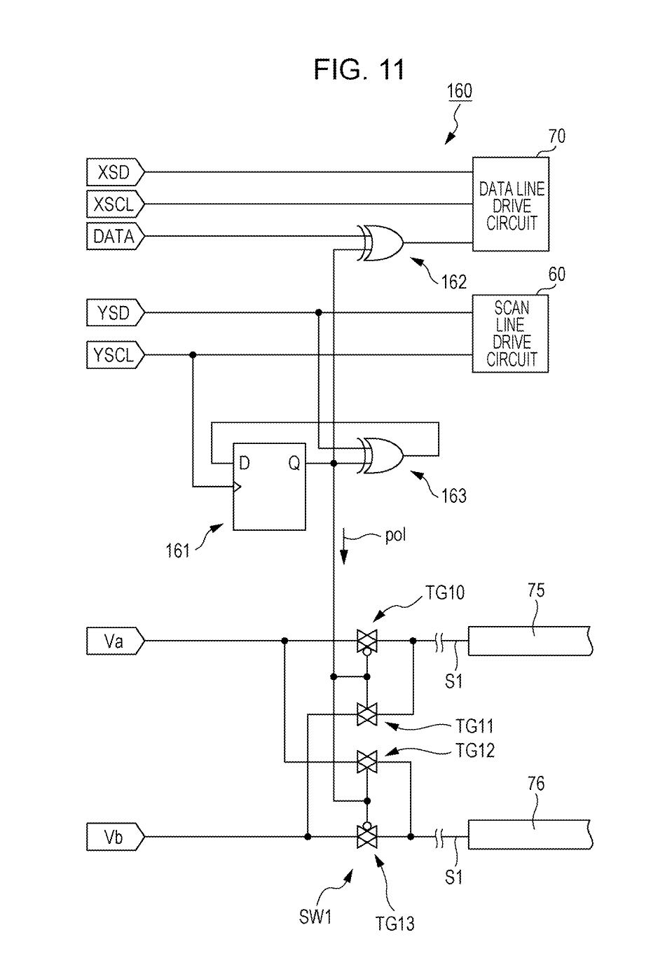

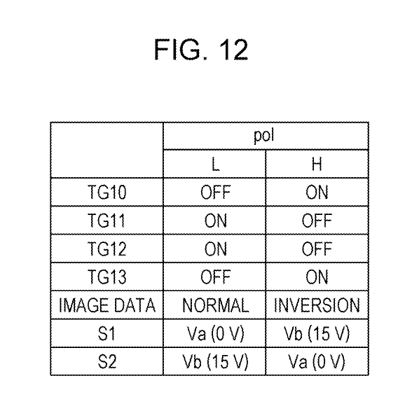

FIG. 11 is a diagram illustrating a schematic configuration of the control circuit 160. In addition, FIG. 12 is a diagram for explaining an operation of the control circuit 160.

As illustrated in FIG. 11, the control circuit 160 includes a flip-flop circuit 161, two exclusive OR (XOR) circuits 162 and 163, and a switch circuit SW1. The switch circuit SW1 includes transfer gates TG10, TG11, TG12, and TG13.

The scan line drive circuit 60 takes in Y start data (YSD) at a rising edge of a clock signal YSCL and selects the scan line 40. At a rising edge of a subsequent Y shift clock (YSCL), selecting the scan line 40 of a certain column is ended, and instead, the scan line 40 of a subsequent row is selected. By doing this, the scan lines 40 are sequentially selected for each rising edge of the YSCL. In addition, the data line drive circuit 70 also operates in the same manner. That is, in a period in which a certain row is selected, X start data (XSD) is taken in at a rising edge of an X shift clock (XSCL), the data line 50 of a certain column is selected, the data line 50 is electrically connected to a source of the pixel 20, and an image writing operation of one pixel corresponding to the selected row and the source line is performed. Subsequently, by making the XSCL rise, a subsequent data line 50 is selected and image writing is performed in the same manner. By doing this, the data lines 50 are sequentially selected for each rising edge of the XSCL. By the above-described operation, all of the image writing of the display unit 3 is completed.

In the present embodiment, an output terminal of the XOR circuit 162 is connected to the data line drive circuit 70, the image data (DATA) is input to one terminal of two input terminals of the XOR circuit 162, and an output Q from the flip-flop circuit 161 is input to the other terminal of the input terminals. The XOR circuit 163 performs exclusive OR on the output Q of the flip-flop circuit 161 and a YSD signal. Then, the exclusive-ORed value becomes an input data D of the flip-flop circuit 161. The flip-flop circuit 161 takes in the input data D in synchronization with a rising edge of the YSCL signal, and uses the input data D as its own output. Here, the output signal is referred to as pol. Then, a signal pol is inverted when the YSD signal goes to H, and only when the YSCL signal rises (only when H)

FIG. 12 illustrates a state of the output signal pol and a table corresponding to each unit. That is, the flip-flop circuit 161 inverts the output signal pol whenever rewriting of an image from the first image to the second image is started, and only when the rewriting is started (when the YSCL signal is rising). Here, when the output signal pol goes to L, the image data DATA from an external portion is supplied to the data line 50 via the scan line drive circuit 60, as it is (denoted by “normal” in FIG. 12).

At this time, if the output signal pol (L) is input to the switch circuit SW, the transfer gates TG10 and TG13 are turned off, and the transfer gates TG11 and TG12 are turned on, as illustrated in FIG. 12. In this case, a power supply voltage Va (for example 0 V) is input to the first control line 75 as the control signal S1, and a power supply voltage Vb (for example 15 V) is input to the second control line 76 as the control signal S2.

Meanwhile, when the output signal pol goes to H, the image data DATA from an external portion is inverted (denoted by “inversion” in FIG. 12) and supplied to the data line 50 via the scan line drive circuit 60.

At this time, if the output signal pol (H) is input to the switch circuit SW, the transfer gates TG10 and TG13 are turned on, and the transfer gates TG11 and TG12 are turned off, as illustrated in FIG. 12. In this case, the power supply voltage Va (for example 0 V) is input to the second control line 76 as the control signal S2, and the power supply voltage Vb (for example 15 V) is input to the first control line 75 as the control signal S1. That is, the inverted image data is input to the data line 50, and potentials that are input to the first control line 75 and the second control line 76 are inverted.

As described above, also in the present embodiment, the first control line 75 and the second control line 76 can undergo binary inversion (0 V or 15 V). For this reason, since the first control line 75 and the second control line 76 have a relative relationship of a potential with regard to the pixel electrode 21 which changes, a repulsive force can be generated with respect to the electrophoretic particles that accumulate in a portion corresponding to the first control line 75 or the second control line 76 in the same manner as in the first embodiment. Thus, it is possible to prevent the electrophoretic particles from accumulating, and to obtain a good display quality without display unevenness.

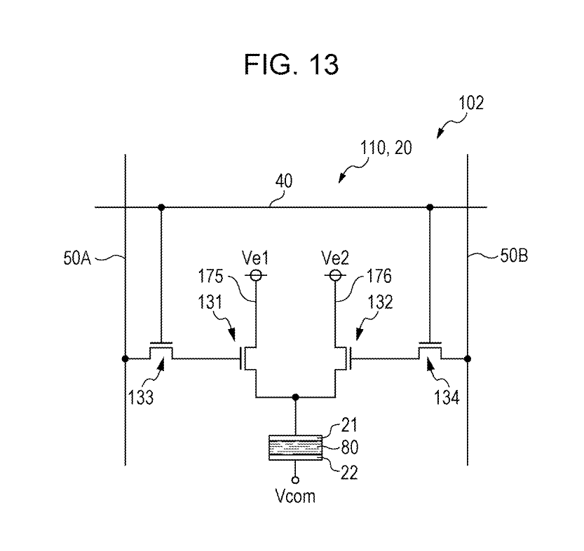

In addition, in the first embodiment or the second embodiment, a configuration in which the pixel 20 includes the pixel switching element 24, the latch circuit 25, the switch circuit SW, the first control line 75 and the second control line 76 that are connected to the switch circuit SW, as a pixel circuit, is used as an example, but the invention is not limited to this. In the invention, if, at the time of image display, any one of two or more control lines (including power supply line) to which a constant potential is applied is electrically connected to the pixel electrode and thereby the electrophoretic element is driven, the configuration of the pixel circuit is not limited. For example, the invention is applicable to even an electrophoretic display device 102 that includes a pixel circuit illustrated in FIG. 13. In addition, FIG. 13 illustrates a pixel circuit 110 of a pixel 20 in a first row and a first column. Since a configuration of each pixel circuit 110 is the same, here the pixel circuit 110 in the first row and the first column will be representatively described. Descriptions with respect to the other pixel circuits 110 will be omitted.

The pixel circuit 110 includes a TFT131 (first transistor), a TFT132 (second transistor), a TFT133 (third transistor), and a TFT134 (fourth transistor). A gate of the TFT133 is connected to the scan line 40, and a source of the TFT133 is connected to a first data line 50A. A gate of the TFT134 is connected to the scan line 40, and a source of the TFT134 is connected to a second data line 50B.

A gate of the TFT131 is connected to a drain of the TFT 133, and a first potential Ve1 is input to a source of the TFT131 by a first control line 175. A gate of the TFT132 is connected to a drain of the TFT 134, and a second potential Vet is input to a source of the TFT132 by a second control line 176. In addition, a drain of the TFT131 and a drain of the TFT132 are connected to the pixel electrode 21.

Next, a drive method at the time of the black display of the pixel 20, and a drive method at the time of the white display of the pixel 20 will be described. When an image is displayed on the pixel 20, the potential Vcom is input to the counter electrode 22. Here, the first potential Ve1 is a higher potential than the potential Vcom, and the second potential Vet is a lower voltage than the potential Vcom.

For example, when the pixel 20 in the first row and first column is displayed in white, a data line drive circuit (not illustrated) supplies a data signal with an H level to the first data line 50A in the first column and supplies a data signal with an L level to the second data line 50B in the first column. If the first data line 50A goes to an H level in a state where the TFT133 is turned on, the gate of the TFT131 goes to an H level and thereby the TFT131 is turned on. In addition, if the second data line 50B goes to an L level in a state where the TFT134 is turned on, the gate of the TFT132 goes to an L level and thereby the TFT132 is turned off. If the TFT131 is turned on and the TFT132 is turned off, the first potential Ve1 is input to the pixel electrode 21 by the first control line 175. Here, since the potential of the pixel electrode 21 is higher than the potential Vcom that is input to the counter electrode 22, the white electrophoretic particles that are positively charged move to the counter electrode 22 side, and the black electrophoretic particles that are negatively charged move to the pixel electrode 21 side, in the electrophoretic layer 80.

Meanwhile, for example, when the pixel in the first row and first column is displayed in black, in a period in which the scan line 40 in the first row is at an H level, a data line drive circuit (not illustrated) supplies a data signal with an L level to the first data line 50A in the first column and supplies a data signal with an H level to the second data line 50B in the first column. If the first data line 50A goes to an L level in a state where the scan line 40 goes to an H level and thereby the TFT133 is turned on, the gate of the TFT131 goes to an L level and thereby the TFT131 is turned off. In addition, if the second data line 50B goes to an H level in a state where the scan line 40 goes to an H level and thereby the TFT134 is turned on, the gate of the TFT132 goes to an H level and thereby the TFT132 is turned on. If the TFT131 is turned off and the TFT132 is turned on, the second potential Vet is input to the pixel electrode 21 by the second control line 176. Here, since the potential of the pixel electrode 21 is a lower voltage than the potential Vcom that is input to the counter electrode 22, the black electrophoretic particles that are negatively charged move to the pixel electrode 21 side, and the white electrophoretic particles that are positively charged move to the counter electrode 22 side, in the electrophoretic layer 80.

According to the pixel circuit 110 illustrated in FIG. 13, when the display of the pixel 20 is changed, the application of a voltage to the pixel electrode 21 is ended only once, and thus it is possible to suppress power consumption. In addition, since it is possible to make different voltages that are applied to the pixel electrode 21 for each pixel 20, by selecting the scan line 40 once, some pixels can be changed to the black display and the other pixels can be changed to the white display, in the pixels 20 in the same row. In addition, since a memory is not provided for each pixel, it is possible to obtain higher definition compared to a configuration in which a memory circuit (latch circuit) is provided for each pixel.

Also in the invention, in the above-described pixel circuit 110, when the image of the display unit 3 is switched, the potentials that are input to the first control line 175 and the second control line 176 are inverted, and the image data is inverted, and thus it is possible to prevent the electrophoretic particles from accumulating in a portion corresponding to the first control line 175 and the second control line 176.

### Electronic Apparatus

Next, a case where the electrophoretic display devices according to each embodiment described above are applied to an electronic apparatus will be described.

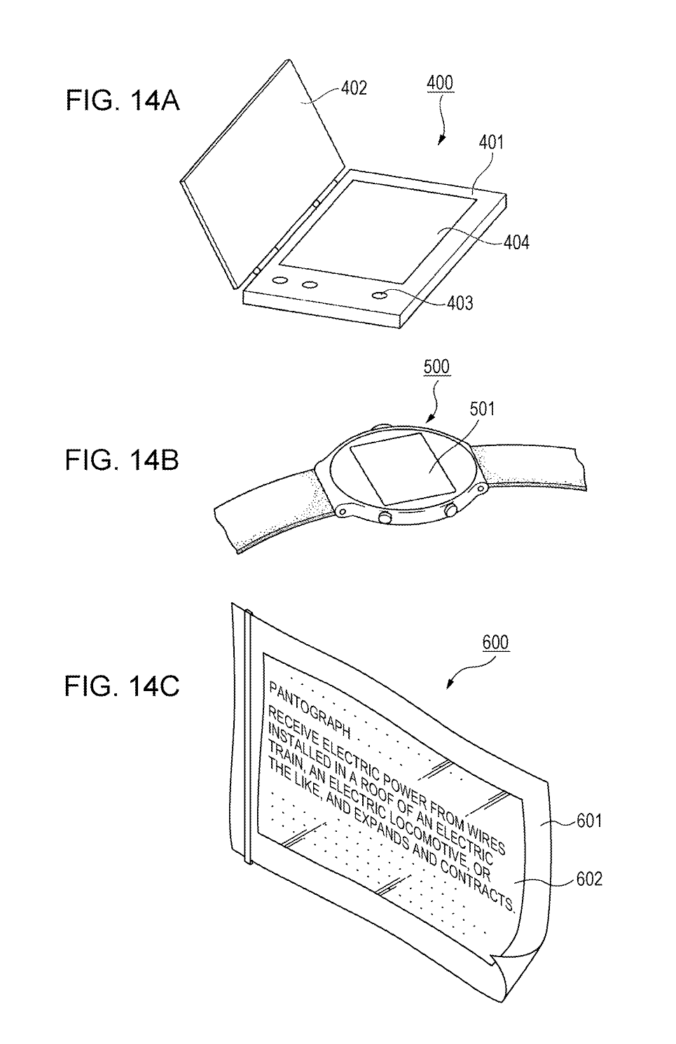

FIGS. 14A to 14C are perspective views for explaining a specific example of an electronic apparatus to which the electrophoretic display devices according to the invention are applied.

FIG. 14A is a perspective view illustrating an electronic book that is an example of the electronic apparatus. The electronic book (electronic apparatus) 400 includes a frame 401 in a book shape, a cover 402 that is rotatably provided (openable and closeable) with respect to the frame 401, an operation unit 403, and a display unit 404 that is configured by the electrophoretic display device according to the invention.

FIG. 14B is a perspective view illustrating a watch that is an example of the electronic apparatus. The watch (electronic apparatus) 500 includes a display unit 501 that is configured by the electrophoretic display device according to the invention.

FIG. 14C is a perspective view illustrating an electronic paper that is an example of the electronic apparatus. The electronic paper (electronic apparatus) 600 includes a main body unit 601 that is configured by a rewritable sheet with the same texture and flexibility as paper, and a display unit 602 that is configured by the electrophoretic display device according to the invention.

For example, it is assumed that the electronic book, the electronic paper, or the like is used for characters to be repeatedly written on a white background, and thus it is necessary for display unevenness to be removed.

In addition, a scope of an electronic apparatus to which the electrophoretic display device according to the invention is applicable is not limited, and includes in a broad sense a device that uses a change in a visual color tone caused by movement of charged particles.

According to the electronic book 400, the watch 500, and the electronic paper 600 that are described above, since the electrophoretic display device according to the invention is adopted, the display unevenness is suppressed, and thereby display characteristics with a high quality can be obtained. Thus, it is possible to provide an electronic apparatus with a high quality and high reliability.

In addition, the above-described electronic apparatus exemplifies the electronic apparatus according to the invention, and is not intended to limit a technical scope of the invention. For example, the electrophoretic display device according to the invention can also be appropriately used for a display unit of an electronic apparatus such as a mobile phone or mobile audio apparatus, commercial sheet such as a manual, a textbook, an exercise book, information sheets, or the like.

The entire disclosure of Japanese Patent Application No. 2014-008794, filed Jan. 21, 2014 is expressly incorporated by reference herein.

What is claimed is:

1. An electrophoretic display device comprising:
a pair of substrates;
an electrophoretic layer that is interposed between the pair of substrates and includes partition walls, and electrophoretic particles disposed in a plurality of areas partitioned by the partition walls;
a display unit that includes a plurality of pixels;
pixel electrodes that are formed in the plurality of pixels;
a data line that is connected to the pixel;
a counter electrode that opposes the plurality of pixel electrodes via the electrophoretic layer;
a first control line and a second control line that are electrically connected to the pixel electrodes and do not overlap the partition walls in a planar view; and
a control device that, when an image that is displayed on the display unit is switched from a first image to a second image, performs a first control operation that replaces a first control signal which is input to the first control line with a second control signal which is input to the second control line so that the second control signal is input to the pixel electrode using the first control line and the first control signal is input to the pixel electrode using the second control line, when the first image is displayed on the display unit before the image is switched, and performs a second control operation that generates inversion image data which is obtained by inverting image data corresponding to the second image, and inputs the inversion image data to the data line.

2. The electrophoretic display device according to claim 1,
wherein, when a period from selection start to selection end of a plurality of scan lines that are connected to the pixels is set as one frame period, the control device performs the first control operation and the second control operation, in at least the one frame period.

3. An electrophoretic display device comprising:
a pair of substrates;
an electrophoretic layer that is interposed between the pair of substrates and includes partition walls, and electrophoretic particles disposed in a plurality of areas partitioned by the partition walls;
a display unit that includes a plurality of pixels;
pixel electrodes that are formed in the plurality of pixels;
a data line that is connected to the pixel;
a counter electrode that opposes the plurality of pixel electrodes via the electrophoretic layer;
a first control line and a second control line that are electrically connected to the pixel electrodes and do not overlap the partition walls in a planar view; and
a circuit unit that, when an image that is displayed on the display unit is switched from a first image to a second image, performs first processing that replaces a first control signal which is input to the first control line with a second control signal which is input to the second control line so that the second control signal is input to the pixel electrode using the first control line and the first control signal is input to the pixel electrode using the second control line, when the first image is displayed on the display unit before the image is switched, and performs second processing that generates inversion image data which is obtained by inverting image data corresponding to the first image, and inputs the inversion image data to the data line.

4. The electrophoretic display device according to claim 3,
wherein, when a period from selection start to selection end of a plurality of scan lines that are connected to the pixels is set as one frame period, the circuit unit performs the first processing and the second processing, in at least the one frame period.

5. A drive method of an electrophoretic display device including a pair of substrates, an electrophoretic layer that is interposed between the pair of substrates and includes partition walls and electrophoretic particles disposed in a plurality of areas partitioned by the partition walls, a display unit that includes a plurality of pixels, pixel electrodes that are formed in the plurality of pixels, a data line that is connected to the pixel, a counter electrode that opposes the plurality of pixel electrodes via the electrophoretic layer, and a first control line and a second control line that are electrically connected to the pixel electrodes and do not overlap the partition walls in a planar view, the method comprising:
performing first processing that, when an image that is displayed on the display unit is switched from a first image to a second image, replaces a first control signal which is input to the first control line with a second control signal which is input to the second control line so that the second control signal is input to the pixel electrode using the first control line and the first control signal is input to the pixel electrode using the second control line, when the first image is displayed on the display unit before the image is switched; and
performing second processing that, when an image that is displayed on the display unit is switched from a first image to a second image, generates inversion image data which is obtained by inverting image data corresponding to the first image, and inputs the inversion image data to the data line.

6. The drive method of an electrophoretic display device according to claim 5,
wherein, when a period from selection start to selection end of a plurality of scan lines that are connected to the pixels is set as one frame period, the first processing and the second processing are performed, in at least the one frame period.

7. A control circuit of an electrophoretic display device including a pair of substrates, an electrophoretic layer that is interposed between the pair of substrates and includes partition walls and electrophoretic particles disposed in a plurality of areas partitioned by the partition walls, a display unit that includes a plurality of pixels, pixel electrodes that are formed in the plurality of pixels, a data line that is connected to the pixel, a counter electrode that opposes the plurality of pixel electrodes via the electrophoretic layer, and a first control line and a second control line that are electrically connected to the pixel electrodes and do not overlap the partition walls in a planar view, the control circuit performing:
a first operation that, when an image that is displayed on the display unit is switched from a first image to a second image, replaces a first control signal which is input to the first control line with a second control signal which is input to the second control line so that the second control signal is input to the pixel electrode using the first control line and the first control signal is input to the pixel electrode using the second control line, when the first image is displayed on the display unit before the image is switched; and
a second operation that, when an image that is displayed on the display unit is switched from a first image to a second image, generates inversion image data which is obtained by inverting image data corresponding to the first image, and inputs the inversion image data to the data line.

8. An electronic apparatus comprising an electrophoretic display device according to claim 1.

9. An electronic apparatus comprising an electrophoretic display device according to claim 2.

10. An electronic apparatus comprising an electrophoretic display device according to claim 3.

11. An electronic apparatus comprising an electrophoretic display device according to claim 4.
